(19) United States
(12) Patent Application Publication
(10) Pub. No.: US 2012/0298566 A1
(43) Pub. Date: Nov. 29, 2012

(54) Ultrasonic Assembly for Pool Cleaners

(76) Inventors: Uri Eli, Kiryat-Ono (IL); Assaf Zilcha, Tel Aviv (IL); Yossi Gofman, Tel Aviv (IL)

(21) Appl. No.: 13/478,428

(22) Filed: May 23, 2012

Related U.S. Application Data
(60) Provisional application No. 61/489,267, filed on May 24, 2011.

(51) Int. Cl. E04H 4/16; B06B 1/00

(52) U.S. Cl. 210/85; 210/167.1; 210/167.11; 210/167.15; 367/140

(57) ABSTRACT

An ultrasonic assembly for pool cleaners which applying ultrasonic energy. According to various embodiments of the present invention, such ultrasonic assembly may optionally be applied to enhance and improve cleaning operation of pools, removing contaminators and handle unneeded biological organisms and waste.

### REFERENCE TO CROSS-RELATED APPLICATION

This Application claims priority from U.S. Provisional Application No. 61/489,267, filed on May 24 2011, which is hereby incorporated by reference as if fully set forth herein.

### FIELD OF THE PRESENT INVENTION

The present invention relates to ultrasonic assembly and the various uses and methods thereof, and in particular to such assembly for pool cleaner devices.

### BACKGROUND OF THE PRESENT INVENTION

A wide variety of pool cleaners and especially swimming pools cleaner's products exist on the market. The decision regarding the most suitable pool cleaner product for a specific pool depends on various parameters such as size and shape of pool, pool usage, type of pool, type of debris load, etc.

In general there are two types of pool cleaner's products, a manual pool cleaner or automatic pool cleaner robot.

A robotic pool cleaner is an automatic cleaner that uses a computerized system to navigate the inside of your swimming pool. It is capable of climbing up the walls as well is crawling along the floor. It contains brushes to scrub, vacuum unit to suck dirt up. Some models also have built-in water filters that can help purify the water of your pool while it is working. They are capable of working without human supervision.

Whatever the type, manual and automatic—pool cleaners have many limitations for example cannot clean contaminators and dirt attached to pool bottom and walls surfaces, they don't penetrate and often miss spots, cracks, corners, wrinkles in floor and slots between tiles, they don't always clean right up the waterline, they don't handle algae problems or other organisms in pools.

These limitations are not enabling a comprehensive pool cleaning solution and cause for example to the need of additional manual brushing and vacuuming operations which consumes more time, effort, and increase cost, requires from pool cleaner unit more cleaning cycles which again consumes more time, energy, cleaner system wear and increases over-all cost In addition it also increases the use of additional costly complementary solutions to further clean contaminators and dirt or mitigate algae or other organisms problems in pools.

High Frequency sound waves can be used for ultrasonic cleaning and can act on substrates like metal, glass, plastics and ceramics. The cleaning operation is conducted by an ultrasound generating transducer which produces ultrasonic waves in the fluid by changing size in concert with an electrical signal oscillating at ultrasonic frequency. This creates compression waves in the liquid such as water which ‘tear’ the liquid apart, leaving behind many millions of microscopic ‘voids’ or ‘partial vacuum bubbles’ (cavitation). These bubbles collapse with enormous energy; temperatures and pressures on the order for example of 5,000 K and 20,000 lbs per square inch are achieved. However, they are so small that they do no more than clean and remove surface dirt and contaminants. The higher the frequency, the smaller the nodes between the cavitation points, which allows for cleaning of more intricate detail.

In addition studies have shown that ultrasound in particular works very well to control, reduce and safely limit algae and unwanted bacteria from forming in wastewater. Furthermore, ultrasound combined with chlorine has demonstrated to enhance to mitigate algae and other unwanted bacteria and organisms by causing the cells to become detached from surfaces, making it easy to chlorine to penetrate the cells and exert an antimicrobial effect.

### SUMMARY OF THE PRESENT INVENTION

There is an unmet need for, and it would be highly useful to have, a swimming pool cleaner that is able to use ultrasonic energy and force for enhanced cleaning.

The present invention overcomes these drawbacks of the background invention by providing a swimming pool cleaner with ultrasonic assembly for enhanced cleaning through the application of ultrasonic energy.

According to various embodiments of the present invention, such enhanced cleaning may optionally be applied for disassembling contaminators and dirt and/or extracting and detaching contaminators and dirt attached to pool bottom and side wall surfaces and/or cleaning in-continues pool surfaces, including but not limited to corners, cracks, wrinkles in floor, joints between tiles, and surface porous and/or reducing and removing algae and other unwanted bacteria and biological organisms and waste both from pool surfaces and water. It should be noted that contaminators for example are including but not limited to oil based compounds, grease, dust, fingerprints and biological waste.

According to various embodiments of the present invention, the assembly applies ultrasonic energy to the bottom and side walls of the pool and to the water itself as part of pool cleaners operation, in order to enhance swimming pool cleaning.

Optionally the level, frequency, angle and/or rate of the ultrasonic energy, are adjusted according to the desired outcome and/or type of pool and/or shape of pool. For example, optionally the amount of applied ultrasound energy is higher for special type of pool surface and/or intensive cleaning after a period in which the pool was not used, and is lower for standard cleaning operation.

In additional example, optionally the effective angle of the applied ultrasound energy on the pool surface is wide, thus enabling the ultrasonic waves to reach corners, surfaces behind obstacles such as but not limited to pool stairs and areas which are problematic to physically reach and clean.

Optionally the ultrasound energy may be applied continuously, in a single burst, multiple bursts, or as pulses, according to the requirements of the application and desired outcome. Sound waves may be viewed as being generally mechanical in that they consist of the vibration of molecules about their equilibrium positions. Sound waves with frequencies above the upper limit that is audible to the human ear (about 17,000 Hz) lie in the ultrasonic range.

According to various embodiments of the present invention, the applied ultrasonic frequency—one frequency or a few frequencies are above 17 kHz (17,000 Hz).

According to various embodiments, there is provided an assembly comprising a housing and support structure, at least one ultrasonic transducer, and at least one electronic portion (which driving the transducer), wherein the at least one ultrasonic transducer and the at least one electronic portion are supported by the housing and support structure.

Optionally, these components may be integrated within one another, producing a single unit comprising all three components.

Optionally and alternatively each of the components may be differentially attached or coupled to one another forming any number of combinations therefrom.

Optionally for example one such conformation may comprise housing and support structure coupled to at least one ultrasonic transducer having an electronic portion incorporated internally.

Optionally the housing and support structure may encase a part of an electronic portion.

Optionally and most preferably the ultrasonic transducers are matched to water or desired liquid.

The ultrasonic assembly for swimming pool cleaner, according to a preferred non limiting embodiment of the present invention, is operated by a power source such as but not limited to DC/AC low-voltage, DC/AC high voltage, solar power, pool pump powered (water pressure) and rechargeable battery.

The ultrasonic assembly according to a preferred non limiting exemplary embodiment of the present invention is preferably introduced to pool water and surfaces within a supporting platform, for example including but not limited to

a robotic pool cleaner, pump powered automatic pool cleaners, manual pool vacuum cleaner, spherical ball or wire mesh frame or the like.

Optionally, the ultrasonic assembly is stably connected to the supporting platform in a number of optional configurations, preferably including but not limited to installation at the bottom of the platform in the vicinity of or the vacuum intake or in-front of the vacuum intake, wherein the extracted contaminators and dirt from the pool surface are vacuumed by the cleaner.

Optionally, the ultrasonic assembly may be coupled across the front and rear of the platform frame and directed towards the pool surface, wherein the ultrasonic waves are able to reach in-continues surfaces such as corners and pool water line.

Optionally, the ultrasonic assembly may be coupled along the left and right sides of the platform frame and directed towards the pool surface, wherein the ultrasonic waves are able increase cleaner surface coverage and reach in-continues surfaces such as corners.

The ultrasonic assembly according to a preferred non limiting exemplary embodiment of the present invention is optionally include disabling unit to disable ultrasonic waves transmission when the ultrasonic assembly is out of water or in shallow water for energy save and safety.

Optionally, the ultrasonic assembly may also use its inherent capabilities to measure distance to pool surfaces, thus enabling to improve the effectiveness of the cleaning algorithm.

In one aspect the present invention literally enhances the removal of contaminators and dirt attached to the bottom and side wall surfaces of a pool by applying ultrasonic energy directed to the surfaces of the pool. The ultrasonic waves applied to the pool surface causes to “cavitation” where the compression waves pull away liquid from the surface so that a tiny empty cavity forms. In effect, the liquid is jumping up and down on the surface and it occasionally jumps so hard that it leaves the surface altogether. Cavities of this sort are unstable and the liquid soon returns to the surface. When it does return, the liquid collides violently with the surface and the liquid's pressure is very high as it transfers all of its momentum to the surface in millionths of a second.

This process causes to contaminators to detach and disassemble, thus cleaning the pool surface. The cleaning effect is achieved regardless of pool type ceramics, vinyl, metal, fiberglass, granite or other. Preferably, the desired cleaning effect is reached at frequencies below 500 kHz where also the change of water quality if it contains agents or the effect on chlorine in water is small.

In another aspect, the present invention not only enhances pool cleaning but also reduces cleaning cycle time, reduces platform maintenance, simplifies pool cleaners design and size which may require less moving parts, fewer brushes, and may also reduce required vacuum power, all result in cost reduction.

In one particular aspect, the present invention provides by applying ultrasonic waves on surfaces of the pool enhanced cleaning of in-continues pool surfaces, including but not limited to pool corners, cracks, wrinkles in floor, joints between ceramic tiles or marmot tiles, and surface porous where the ultrasonic “cavitation” action penetrates and reaches all pool surface.

In another aspect, the present invention enables to reduce and eliminate algae and other unwanted bacteria and biological organisms from the pool surface and water itself The ultrasonic waves cause the organisms cells to detach from pool surfaces, making it easy to chlorine in pool water to penetrate the cells and exert an antimicrobial effect. Furthermore, the usage of pool chemicals can be reduced when ultrasound is used as part of the cleaning cycle. Thus, achieving both pool maintenance and chemical usage cost reduction and minimizing chemical effects on swimmers—eye irritation, damage to hair, damage to swim wear and unpleasant smell. The ultrasonic assembly may optionally be incorporated and/or attached to one or more supporting elements such as but not limited to water heaters to improve ultrasonic waves effectiveness, scrubbing brushes, UV elements, ultrasound media adaptors which may perform ultrasonic waves matching between transducers to water and pool surfaces and also may obtain minimal transmission distance from pool surfaces of at least 1 millimeter apart.

The ultrasonic assembly may optionally be incorporated and/or attached to one or more existing cleaning platforms such as robotic cleaner as an add-on suit in order to combine the benefits of each technology.

Optionally the ultrasonic assembly for pool cleaners and other components may be attached or coupled thereto either during manufacture, during platform retro-fit, or just before use.

In another aspect, this invention may also be used for improving robotic pool cleaners' algorithm by identifying using the ultrasonic return signal the level of contamination and dirt and define the cleaning effort according it. Furthermore, also distances between the platform to the pools walls can be measured with ultrasonic waves which enables to improve robot steering algorithm.

In another aspect, this invention may also be used for cleaning building's exterior surfaces and windows by using robotic unit or the like to emit ultrasonic waves optionally combined with water and/or cleaning solvents and/or scrubbing brushes. Enabling to improve and enhance cleaning operation and reduce cleaning duration.

It should be noted, that all assemblies, pumps, internal power sources and power drivers, passive components such as cables, or the like are referring to items suitable for water and submersible environment as commonly understood by one of ordinary skill in the art to which this invention belongs.

Unless otherwise defined, all technical and scientific terms used herein have the same meaning as commonly understood by one of ordinary skill in the art to which this invention belongs. The materials, methods, and examples provided herein are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to

provide what is believed to be the most useful and readily understood description of the principles and conceptual aspects of the invention.

In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 shows an exemplary, illustrative embodiment of an ultrasonic assembly for manual pool cleaner device according to the present invention in one possible configuration;

FIG. 2 shows an exemplary, illustrative embodiment of an ultrasonic assembly for automatic pool surfaces and water cleaning device according to the present invention in one possible configuration;

FIG. 3A-E shows an exemplary schematic diagrams of optional ultrasonic assemblies pool cleaner to an illustrative embodiment of the present invention;

FIG. 4 is a schematic diagram of an exemplary, illustrative non-limiting embodiment of an ultrasonic assembly for pool surfaces and water cleaning device according to the present invention;

FIG. 5 is a schematic diagram of an exemplary, illustrative non-limiting embodiment of an ultrasonic assembly for miniature pool surfaces and water cleaning device according to the present invention;

FIG. 6 is a schematic diagram of an exemplary, illustrative non-limiting embodiment of an ultrasonic assembly optimal position in reference to vacuum intake of pool cleaner.

FIG. 7 shows an exemplary, illustrative embodiment of an ultrasonic assembly for automatic pool surfaces and water cleaning device comprised from two portions according to the present invention in one possible configuration;

### DETAILED DESCRIPTION OF THE PREFERRED EMBODIMENTS

The present invention is of ultrasonic assembly for swimming pools cleaners that applies ultrasonic energy to pool surfaces and water which improves and enhances pool surface contaminator and dirt cleaning and eliminate or reduce algae and other unwanted bacteria and biological organisms from the pool surface and the water themselves.

The principles and operation of the present invention may be better understood with reference to the drawings and the accompanying description.

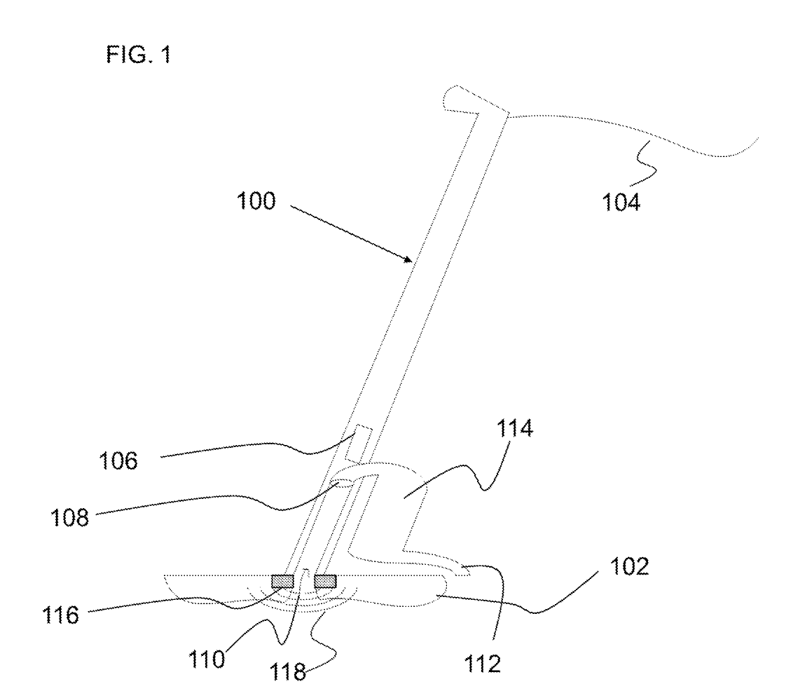

Referring now to the drawings, FIG. 1 shows an exemplary, illustrative embodiment of a manual cleaner with ultrasonic assembly according to the present invention for disassembling contaminators and dirt and/or extracting and detaching contaminators and dirt attached to pool bottom and side wall surfaces and/or cleaning in-continues pool surfaces and/or reducing and removing algae and other unwanted bacteria and biological organisms both from pool surfaces and water.

As shown, a manual cleaner device 100 features a brushes 102 for scrubbing the surfaces of the pool, which is optionally constructed of but not limited to one or more of PVA, rubber, sponge, polyurethane and the like. Hand grip bar and power cable 104 features the manual pool cleaner exterior housing connected to power source such as but not limited to DC or AC low voltage, standard 110/220 VAC grid power.

Optionally, the power source can be integrated and/or coupled within the hand grip bar 104 by using but not limited to internal rechargeable battery power source or the like, thus eliminating the need for external power source and power cable connection. 106 features a water pumping motor, which pumps water through the water intake valve 110, into the filter portion by passing through filter portion inlet 108. An acoustic assembly 116 is integrated and/or coupled within manual cleaner 100 and applying/emitting acoustic energy 118 to the pool surfaces and surrounding water to enhance and/or improve cleaning operation.

Optionally and most preferably the manual cleaner with ultrasonic assembly may be immersed in water.

Optionally, the acoustic assembly 116 may be comprised of one or more transducers producing ultrasonic energy at the desired frequency or different frequencies. The acoustic energy can be varied in time providing different desired energy levels and/or frequencies over time to effectively improve cleaning operation of pool surfaces and/or water. Different frequencies and/or sound waves shapes are optionally generated during operation of device 100.

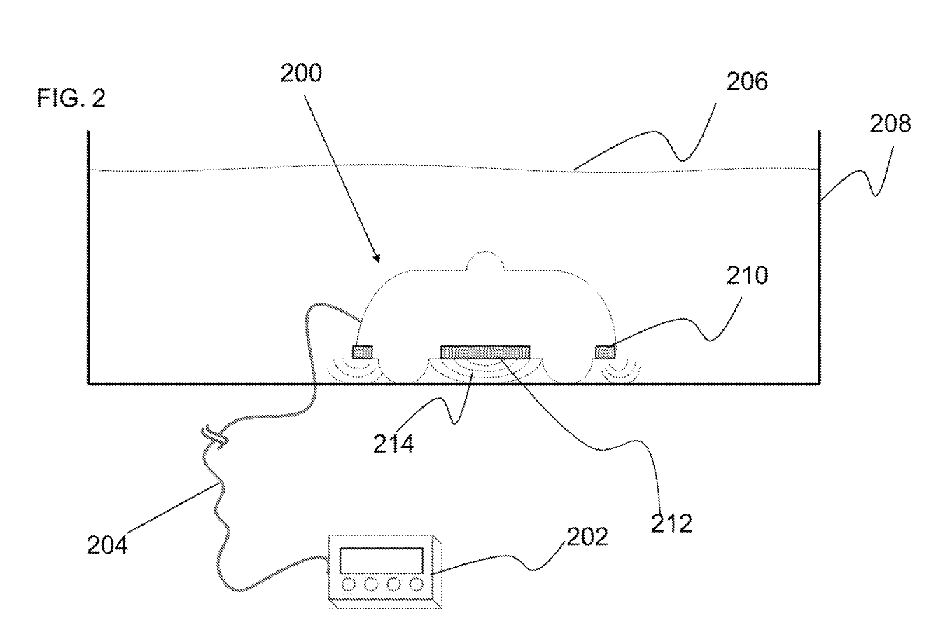

FIG. 2 shows an exemplary, illustrative embodiment of an automatic pool cleaner with ultrasonic assembly according to the present invention for disassembling contaminators and dirt and/or extracting and detaching contaminators and dirt attached to pool bottom and side wall surfaces and/or cleaning in-continues pool surfaces and/or reducing and removing algae and other unwanted bacteria and biological organisms both from pool surfaces and water.

As shown, an automatic pool cleaner device 200 is immersed in pool 208. The pool cleaner unit 200 is connected to power unit 202 via power cable 204. Power unit 202 may provide power feed such as but not limited to DC or AC low voltage, standard 110/220 VAC grid power. Most preferably, power unit 202 supplies 12 VDC-24 VDC power to pool cleaner unit 400 in order to enable safe operation of cleaner also when pool is occupied with people.

Optionally, the power source can be integrated and/or coupled within automatic pool cleaner unit 200 by using but not limited to internal rechargeable battery power source, solar power system or the like, thus eliminating the need for external power source and power cable connection. An acoustic assembly comprised of front and rear acoustic assembly 210 and central acoustic assembly 212 are integrated and/or coupled within automatic cleaner 200 and applying/emitting acoustic energy 214 to the pool surfaces and water below and in the vicinity of the automatic cleaner to enhance and/or improve cleaning operation.

Optionally, the acoustic assembly 210 and/or 212 may be comprised of one or more transducers producing ultrasonic energy at the desired frequency or different frequencies. The acoustic energy can be varied in time providing different desired energy levels and/or frequencies over time to effectively improve cleaning operation of pool surfaces and/or water. Different frequencies and/or sound waves shapes are optionally generated during operation of device 200.

Optionally heaters may be coupled to device 200 such in the vicinity of acoustic assembly 210 and/or 212 to improve cleaning effectiveness,

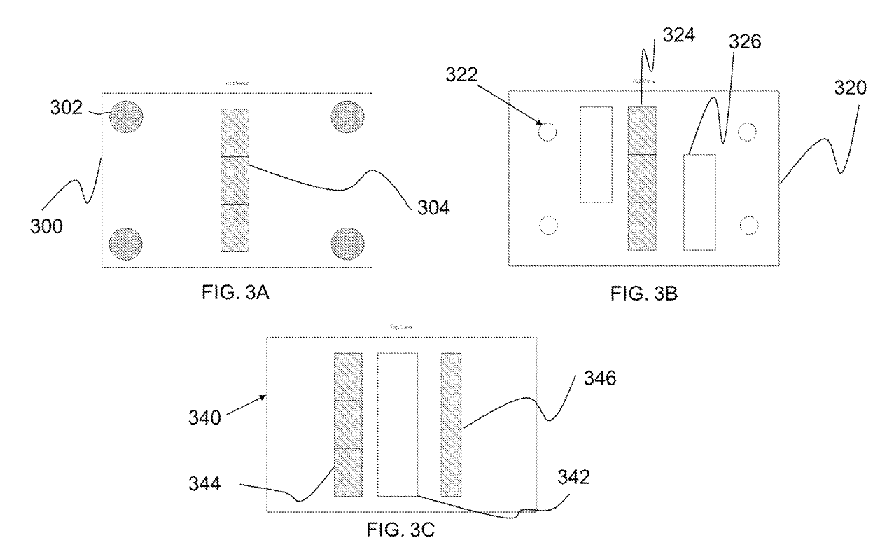

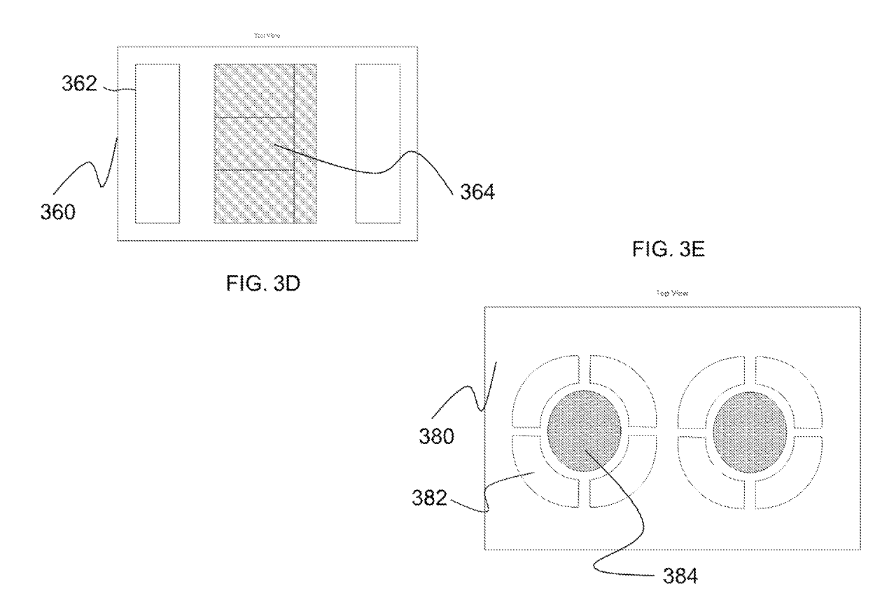

FIG. 3A is a bottom view depiction of a still further non limiting embodiment of the transducers configuration as part of the ultrasonic assembly of the present invention. Frame 300 preferably integrated and/or coupled to bottom part of manual or automatic pool cleaners comprise transducers portion 304 with at least one ultrasonic transducer and at least one water intake. Transducers portion 302 as shown, optionally shaped but not limited to circular, rectangular shape or any other shape, optionally attached/coupled to frame 300 on the exterior perimeter of the frame, and transducers portion 304 with rectangular shape as exemplary illustration as shown, optionally attached to the inner part of frame 300. Transducers portion (302 and 304) which are part of the ultrasonic assembly may produce one or more ultrasonic frequencies such that their ultrasonic waves may optionally overlap or not overlap pending the desired application. Optionally, frame 300 may replace and/or be molded and/or be coupled with ultrasonic assembly housing and support structure which also may incorporate at least one electronic unit which drives at least of transducers.

Optionally additional elements may be coupled to frame 300 such as but not limited to heaters to improve ultrasonic waves effectiveness, solvents injectors' ultrasonic waves effectiveness, brushes or the like.

FIG. 3B is a bottom view depiction of a still further non limiting embodiment of frame 320 preferably integrated and/or coupled to bottom part of manual or automatic pool cleaners and incorporated with water jets injectors 322 and water vacuum intakes 326 (connected to vacuum filter portion, not shown). Ultrasonic transducers portion 324 may have at least one transducer, optionally shaped but not limited to circular, rectangular shape or any other shape. For example, as shown ultrasonic transducers 324 comprised of three transducers. During operation, the disassembled and/or detached contaminators, dirt and biological organisms or the like due to the applied ultrasonic energy is directed to vacuum intakes 326 during the vacuum operation regardless the cleaner direction into the filter portion (not shown) where the contaminators, dirt and biological organism or the like can be contained by the filter portion.

Optionally, the filter portion may withhold and destroy contaminators, dirt and biological organism by incorporating filters with suitable porous size and/or heating device and/or additional ultrasonic transducer applying ultrasonic energy to the contained biological organism and destroying it.

Optionally additional elements may be coupled to frame 320 such as but not limited to heaters to improve ultrasonic waves effectiveness, solvents injectors' ultrasonic waves effectiveness, brushes or the like.

FIG. 3C is a bottom view depiction of a still further non limiting embodiment of the transducers configuration as part of the ultrasonic assembly of the present invention. Frame 340 preferably integrated and/or coupled to bottom part of manual or automatic pool cleaners comprise at least one ultrasonic transducer. Transducers portion 344 and 346 as shown, optionally shaped but not limited to circular, rectangular shape or any other shape, optionally attached/coupled to frame 340 on both sides of water vacuum intake 342, optionally may be positioned in any other position in reference to vacuum intake 342. Transducers portion (344 and 346) which are part of the ultrasonic assembly may produce one or more ultrasonic frequencies such that their ultrasonic waves may optionally overlap or not overlap pending the desired application.

Optionally, frame 340 may replace and/or be molded and/or be coupled with ultrasonic assembly housing and support structure which also may incorporate at least one electronic unit which drives at least of transducers.

Optionally additional elements may be coupled to frame 340 such as but not limited to heaters to improve ultrasonic waves effectiveness, solvents injectors' ultrasonic waves effectiveness, brushes or the like.

FIG. 3D is a bottom view depiction of a still further non limiting embodiment of the transducers configuration as part of the ultrasonic assembly of the present invention. Frame 360 preferably integrated and/or coupled to bottom part of manual or automatic pool cleaners. Ultrasonic transducers portion 364 may have at least one transducer, optionally shaped but not limited to circular, rectangular shape or any other shape, optionally attached/coupled to frame 360 between water vacuum intakes 362. Transducers portion 364 which are part of the ultrasonic assembly may produce one or more ultrasonic frequencies such that their ultrasonic waves may optionally overlap or not overlap pending the desired application.

Optionally, frame 360 may replace and/or be molded and/or be coupled with ultrasonic assembly housing and support structure which also may incorporate at least one electronic unit which drives at least of transducers.

FIG. 3E is a bottom view depiction of a still further non limiting embodiment of the transducers configuration as part of the ultrasonic assembly of the present invention. Frame 380 preferably integrated and/or coupled to bottom part of manual or automatic pool cleaners. Ultrasonic transducers portion 384 may have at least one transducer, optionally shaped but not limited to circular, rectangular shape or any other shape, optionally attached/coupled to frame 380 between water vacuum intakes 382. Transducers portion 384 which are part of the ultrasonic assembly may produce one or more ultrasonic frequencies such that their ultrasonic waves may optionally overlap or not overlap pending the desired application.

transducers portion 384 is preferably positioned coaxially to water vacuum intakes 382 axel enables during the appliance of acoustic energy, that the disassembled and/or detached contaminators, dirt and biological organisms or the like due to the applied ultrasonic energy to be directed to water vacuum intakes 382 during the vacuum operation regardless the cleaner direction. Thus, minimizing the amount of disassembled and/or detached contaminators, dirt and biological organisms or the like to “break free” and not be filtered by the filter portion (not shown) which may cause to reduce water clarity and may prolong cleaning operation. Due to the fact that acoustic energy beam can be angular and has side lobs, most preferably the transducers portion 384 circumference is enclosed within the water vacuum intakes 382 contour (i.e., water intake cross section is entirely overlapping the ultrasonic assembly cross-section.

Optionally, frame 380 may replace and/or be molded and/or be coupled with ultrasonic assembly housing and support structure which also may incorporate at least one electronic unit which drives at least of transducers.

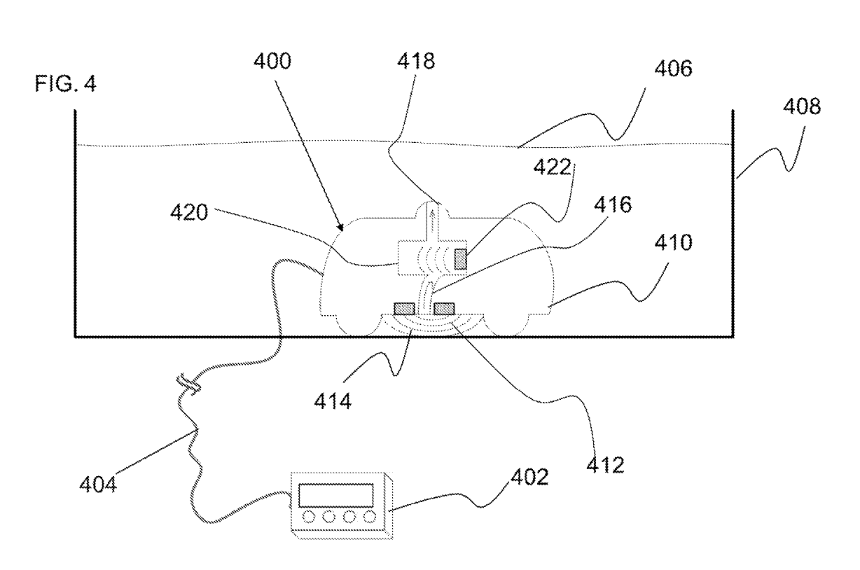

FIG. 4 shows an exemplary, illustrative embodiment of an automatic pool cleaner with ultrasonic assembly according to the present invention where a second layer of ultrasonic waves emitted for reducing and removing algae and other unwanted bacteria and biological organisms contained in filter portion and/or passing through filter portion.

As shown, an automatic pool cleaner unit 400 is immersed in pool 408. The pool cleaner unit 400 is connected to power unit 402 via power cable 404. Power unit 202 may provide power source such as but not limited to DC/AC low voltage, standard 110/220 VAC grid power or any other power type. Most preferably, power unit 202 supplies 12 VDC-24 VDC power to pool cleaner unit 400 in order to enable safe operation of cleaner also when pool is occupied with people.

Optionally, the power source can be integrated and/or coupled within automatic pool cleaner unit 400 by using but not limited to internal rechargeable battery power source or the like, thus eliminating the need for external power source and power cable connection.

An ultrasonic assembly comprised of at least one transducers portion 412 are integrated and/or coupled within automatic cleaner 400 and applying/emitting ultrasonic energy 414 to the pool surfaces and water underneath. A second layer of transducers portion 422 is applying ultrasonic energy on filter portion chamber/bag 420. The applied energy reacts both on contained contaminators and biological organisms and on passing water entering from vacuum water intake 416 and existing from outlet 418 in order to further destroy these contaminators and biological organisms.

Optionally, the ultrasonic assembly 412 may be comprised of at least one transducer and ultrasonic power driver (generator) which receives power from power unit 402 and generates power signal in the required frequency and voltage matched to the transducer in order to activate the transducer. The ultrasonic assembly 412 is producing ultrasonic energy at the desired frequency or different frequencies. The acoustic energy can be varied in time providing different desired energy levels and/or frequencies over time to effectively improve cleaning operation of pool surfaces and/or water. Different frequencies and/or sound waves shapes are optionally generated during operation of device 400.

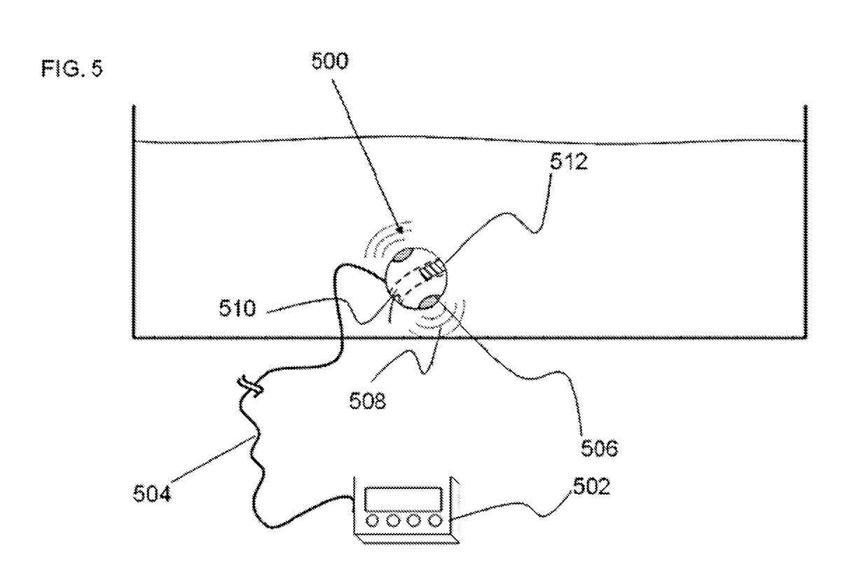

FIG. 5 shows an exemplary, illustrative non-limiting embodiment of a device according to the present invention. As shown, a device 500 features an ultrasonic assembly cleaner and a power source 502 such as but limited to DC/AC low voltage power, Grid Power via power cable 504 for operating the device 500.

Optionally, the power source can be integrated and/or coupled within device 500 by using but not limited to internal rechargeable battery power source or the like, thus eliminating the need for external power source and power cable connection.

Optionally, alternative power source may be provided to device 500 by a method of water pressure by connecting device 500 via a hose to pool's circulation system, enabling device 500 both movement generated from the flowing water and harvesting energy for the ultrasonic assembly.

Device 500 may optionally be shaped in spherical form, disc form, spring-like, holder that extends from the pool, miniature robotic cleaner or the like, where the ultrasonic assembly 506 comprised of at least one transducer and ultrasonic power driver (generator) which receives power from power source 502 and generates power signal in the required frequency and voltage matched to the transducer in order to activate the transducer. Ultrasonic assembly 506 are integrated, coupled or attached within device 500 and applying/emitting ultrasonic energy 508 to the pool surfaces and water underneath and in the vicinity to device 500.

Optionally, Device 500 may include electric pump portion 510 to vacuum the water and filter portion 512 to contain the contaminator cleaned from the pool. Optionally still, electric pump portion 510 may also steer and move device 500 using its propeller (not shown).

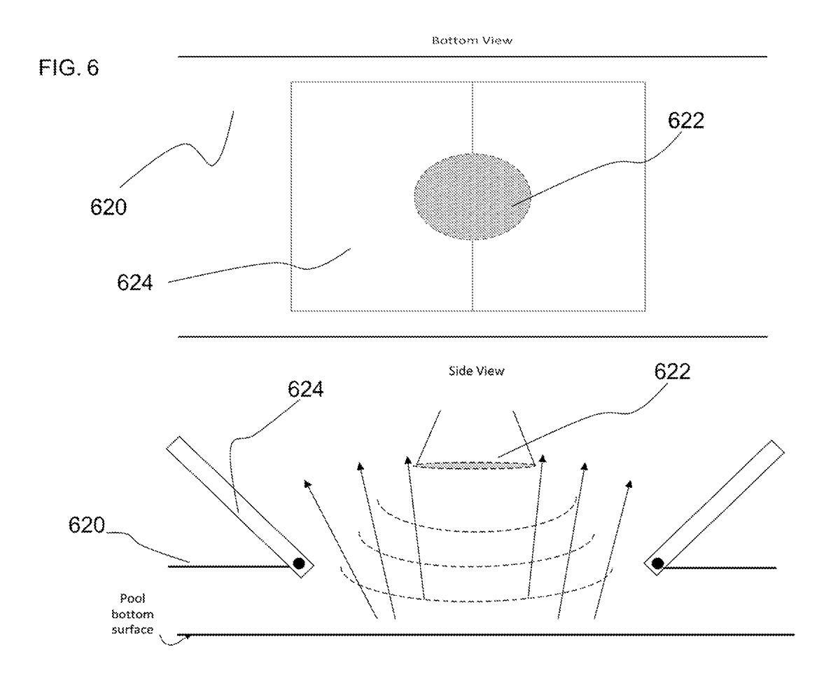

FIG. 6 is a bottom and side view depiction of a still further non limiting embodiment of structure 620 preferably comprise ultrasonic assembly 622 with at least one ultrasonic transducer and a water intake 624.

Ultrasonic assembly 622 transducers, optionally may be shaped as but not limited to circular, rectangular shape or any other shape.

Ultrasonic assembly 622 is preferably positioned coaxially to water intake 624 axel enables during the appliance of acoustic energy, that the disassembled and/or detached contaminators, dirt and biological organisms or the like due to the applied ultrasonic energy to be directed to water intake 624 during the vacuum operation regardless the cleaner direction into the filter portion (not shown). Thus, minimizing the amount of disassembled and/or detached contaminators, dirt and biological organisms or the like to “break free” and not be filtered by the filter portion (not shown) which may cause to reduce water clarity and may prolong cleaning operation. Due to the fact that acoustic energy beam can be angular and has side lobs , most preferably the ultrasonic assembly 622 circumference is enclosed within the water intake 624 contour (i.e., water intake cross section is entirely overlapping the ultrasonic assembly cross-section) to vacuum maximum disassembled and/or detached contaminators, dirt and biological organisms or the like to enter the water intake 624.

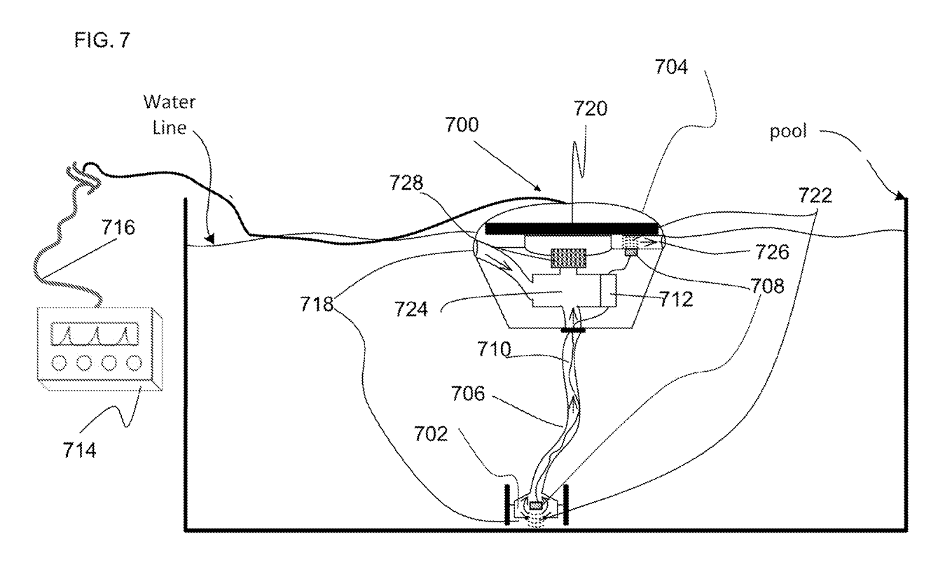

FIG. 7 shows an exemplary, illustrative non-limiting embodiment of a device according to the present invention. As shown, a device 700 comprised from two parts: submersible part 702 vacuuming and cleaning the pool bottom surface and semi-submersible part 704 vacuuming and cleaning the water line of the pool with floating element 720. The connection between the submersible part 702 and semi-submersible part 704 is preferably performed by flexible vacuum water hose 706. Optionally hose 706 may also be floating type hose and optionally may circular adaptor enabling 360 degrees rotation (not shown) connected to the hose at least in one end.

The ultrasonic assembly 708 embedded in submersible part 702 and optionally embedded also in semi-submersible part 704, where the ultrasonic assembly 708 is activated by preferably connecting to ultrasonic power driver (generator) 712 via power cables 710 which is activating the ultrasonic assembly 708 transducers. Preferably, power cable 710 that is connecting the ultrasonic assembly 708 embedded in the submersible part 702 to the ultrasonic power driver (generator) 712 is coupled, integrated, attached or molded in flexible vacuum water hose 706.

Optionally, the power source can be integrated and/or coupled within device 700 by using but not limited to internal rechargeable battery power source, solar system or the like, thus eliminating the need for external power source and power cable connection.

Water intakes 718 may optionally and most preferably embedded both in submersible part 702 and semi-submersible part 704 enabling to vacuum dirt, debris, contaminators or the like both from pool bottom surface and water line, respectively.

The pumping operation enabling water to be vacuumed via water intakes 718, and go through the cleaning process by device 700 until discharged from water outlets 726, can optionally be performed by submersible electric pump 728. Optionally more the pumping operation can be obtained by connecting to device 700 to pool's water circulation system (not shown).

Device power source 714 is connected to submersible electric pump 728 and to the ultrasonic power driver (generator) 712 proving DC or AC low voltage power or Grid Power 110/220 VAC via power cable 716. Most preferably, power source 714 supplies 12 VDC-24 VDC power in order to enable safe operation of cleaner also when pool is occupied with people.

Optionally the ultrasonic assembly 708 will serve a water indicator by using the acoustic matching characteristic of the ultrasound assembly 708 to water, when exposed to air the acoustic mismatch will dramatically reduce the emitted power and will also reduce the current fed to the ultrasonic assembly 708. Thus, enables to detect that device 700 is not is required state and disable device 700 until meeting the required operative state.

Optionally heaters may be coupled to device 700 such in the vicinity of ultrasonic assembly 708 to improve cleaning effectiveness,

Device 700 may optionally be shaped in spherical form, disc form, spring-like, holder that extends from the pool, small sized robotic cleaner or the like, where the ultrasonic assembly 708 applying/emitting ultrasonic energy 722 both to the pool surface and to the water filtered by filter portion 724 within device 700 to further clean and purify the water . Optionally, a cleaning substance stored in device 700 such as but not limited to chlorine is introduced to the water before entering to at least one of the emitted acoustic energy stage and most preferably before entering to the emitted acoustic energy stage of the semi-submersible part 704, thus enabling the ultrasonic energy 722 to be emitted on mixed water and cleaning substance, thus greatly improve cleaning and purification of water.

While the invention has been described with respect to a limited number of embodiments, it will be appreciated that many variations, modifications and other applications of the invention may be made.

What is claimed is:

1. An ultrasonic assembly comprised of:
a. at least one transducer;
b. ultrasonic power driver (generator);

2. An ultrasonic assembly according to claim 1, wherein said at least one transducer and said ultrasonic power driver are integrated, coupled, attached or molded to cleaning platform frame or to the bottom part of manual or automatic robotic pool cleaner.

3. A pool cleaner device according to claim 2, wherein said at least one transducer is integrated , coupled, attached or molded to water vacuum intake.

4. A pool cleaner device with ultrasonic assembly comprised of:
a. at least one ultrasonic assembly;
b. at least one water outlet;
c. at least one water intake;
d. filter portion

5. A pool cleaner device according to claim 4, wherein said at least one ultrasonic assembly is applying acoustic energy to water.

6. A pool cleaner device according to claim 4, wherein said at least one ultrasonic assembly is integrated , coupled or attached to said at least one water intake.

7. A pool cleaner device according to claim 6, wherein said at least one ultrasonic assembly circumference is enclosed within said at least one water intake contour.

8. A pool cleaner according to claim 6, wherein said at least one ultrasonic assembly is positioned coaxially to said at least one water intake axel.

9. A pool cleaner device according to claim 4, wherein said at least one ultrasonic assembly is integrated, coupled or attached to said at least one water outlet.

10. A pool cleaner device according to claim 9, further introducing cleaning substance to water before interaction with acoustic energy of said at least one ultrasonic assembly stage.

11. A pool cleaner device according to claim 4, wherein said at least one ultrasonic assembly is integrated, coupled or attached to said filter portion.

12. A pool cleaner device according to claim 11, further introducing cleaning substance to water before interaction with acoustic energy of said at least one ultrasonic assembly stage.

13. A pool cleaner device according to claim 4, wherein said at least one ultrasonic assembly is serving also as water indicator.

14. A pool cleaner device according to claim 4, wherein said at least one ultrasonic assembly is integrated, coupled or attached to said at least one water intake and also to said at least one water outlet.

15. A pool cleaner device according to claim 14, further introducing cleaning substance to water before interaction with acoustic energy of said at least one water outlet.

16. A pool cleaner device according to claim 14, further comprising submersible part for vacuuming and cleaning the pool bottom surface and semi-submersible part for vacuuming and cleaning the water line of the pool with floating element.

17. A pool cleaner device according to claim 16, wherein connection between said submersible part and said semi-submersible part is preferably performed by flexible vacuum water hose

18. A pool cleaner device according to claim 17, wherein a power connecting cable is coupled, integrated, attached or molded in said flexible vacuum water hose.
